(19) United States
(12) Patent Application Publication
(10) Pub. No.: US 2019/0271869 A1
(43) Pub. Date: Sep. 5, 2019

(54) LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Wu CAO, Shenzhen (CN)

(21) Appl. No.: 16/045,029

(22) Filed: Jul. 25, 2018

Related U.S. Application Data
(63) Continuation of application No. PCT/CN2018/080855, filed on Mar. 28, 2018.

(30) Foreign Application Priority Data
Mar. 1, 2018 (CN) 201810171705.8

(51) Int. Cl. G02F 1/1339; G02F 1/1333

(52) U.S. Cl. CPC G02F 1/1339; G02F 1/133308

(57) ABSTRACT

A liquid crystal display panel is disclosed. The panel includes: an upper substrate, wherein an inner surface of the upper substrate is provided with a first spacer, and the first spacer includes a first flat portion and a first protrusion portion protruded from an end of the first flat portion, a lower substrate disposed oppositely to the upper substrate, wherein an inner surface of the upper substrate is provided with a second spacer, and the second spacer includes a second flat portion and a second protrusion portion protruded from an end of the second flat portion. During the process of aligning and assembling the upper substrate and the lower substrate, the first protrusion portion presses against the second flat portion and/or the second protrusion portion presses against the first flat portion in order to support and interlock the upper and lower substrates.

### CROSS REFERENCE

This application is a continuing application of PCT Patent Application No. PCT/CN2018/080855, entitled “LIQUID CRYSTAL DISPLAY PANEL”, filed on Mar. 28, 2018, which claims priority to China Patent Application No. 201810171705.8, filed on Mar. 1, 2018, both of which are hereby incorporated in its entireties by reference.

### FIELD OF THE INVENTION

The present invention relates to the field of panel evaporation process, and more particular to a liquid crystal display panel.

### BACKGROUND OF THE INVENTION

In the process of manufacturing a flat liquid crystal display panel into a curved liquid crystal display panel, since the curved liquid crystal panel has a certain curvature, a relative slip and dislocation between an array substrate and a color filter substrate is generated after bending, and the dislocation between the two substrates is increased from the center toward both sides. At the same time, compression stress is generated between the two substrates, and the compression stress gradually decreases from the center to both sides, resulting in an uneven cell gap at the center and both ends of the curved display such that display quality is decreased or poor.

In the existing LCD packaging technology, spacers are required to support upper and lower substrates in order to form a liquid crystal thickness. According to different heights, generally, spacers including Main PS (main photoresist spacer) and Sub PS (sub photoresist spacer) are provided. At the same time, there are BM-type spacers that conform to the material of the main PS and Sub PS and can be integrally formed. The technical problem of the liquid crystal display panel with the above spacers is that two kinds of spacers are required to be fabricated separately on the two sides of the substrate, and the number of spacers is large, which occupies a large space.

Therefore, it is necessary to provide a liquid crystal display panel to solve the above technical problems.

### SUMMARY OF THE INVENTION

The technical problem to be solved by the present invention is to provide a liquid crystal display panel, which can improve the compression resistance, support the formation of a cell thickness, and can form a secondary support when deformed by a large external force; the upper and lower substrates form a complete gap after aligning and assembling, and can effectively prevent slip misalignment of the upper and lower substrates.

In order solve the above technology problem, the present invention provides a liquid crystal display panel, comprising: an upper substrate, wherein an inner surface of the upper substrate is provided with a first spacer, and the first spacer includes a first flat portion and a first protrusion portion protruded from an end of the first flat portion; a lower substrate disposed oppositely to the upper substrate, wherein an inner surface of the upper substrate is provided with a second spacer, and the second spacer includes a second flat portion and a second protrusion portion protruded from an end of the second flat portion; wherein during the process of aligning and assembling the upper substrate and the lower substrate, the first protrusion portion presses against the second flat portion and/or the second protrusion portion presses against the first flat portion in order to support and interlock the upper and lower substrates.

Wherein the first protrusion portion has a first top surface, the first flat portion has a second top surface, and a step difference is provided between the first top surface and the second top surface.

Wherein the second protrusion portion has a third top surface, the second flat portion has a fourth top surface, and a step difference is provided between the third top surface and the fourth top surface.

Wherein the second protrusion portion has a third top surface, the second flat portion has a fourth top surface, and a step difference is provided between the third top surface and the fourth top surface.

Wherein the first top surface contacts and presses against the fourth top surface, and a gap is existed between the third top surface and the second top surface such that the third top surface and the second top surface are not contacted.

Wherein the third top surface contacts and presses against the second top surface, and a gap is existed between the first top surface and the fourth top surface such that the first top surface and the fourth top surface are not contacted.

Wherein the first top surface contacts and presses against the fourth top surface, and the third top surface contacts and presses against the second top surface.

Wherein a liquid crystal layer is sandwiched between the upper substrate and the lower substrate, and polarized films respectively disposed on outside surfaces the upper substrate and the lower substrate.

Wherein multiple first spacers are formed at an inner surface of the upper substrate as an array, multiple second spacers are formed at an inner surface of the lower substrate as an array, when the upper substrate and the lower substrate are aligned and assembled, any first spacer at the upper substrate contacts or compresses the second spacer at the lower substrate in order to form a complete spacer structure.

Wherein a material of the first spacer and a material of the second spacer are the same.

In order to solve the above technology problem, the present invention also provides a liquid crystal display panel, comprising: an upper substrate, wherein an inner surface of the upper substrate is provided with a first spacer, and the first spacer includes a first flat portion and a first protrusion portion protruded from an end of the first flat portion; a lower substrate disposed oppositely to the upper substrate, wherein an inner surface of the upper substrate is provided with a second spacer, and the second spacer includes a second flat portion and a second protrusion portion protruded from an end of the second flat portion; wherein during the process of aligning and assembling the upper substrate and the lower substrate, the first protrusion portion presses against the second flat portion and/or the second protrusion portion presses against the first flat portion in order to support and interlock the upper and lower substrates; wherein a material of the first spacer and a material of the second spacer are the same; and wherein a liquid crystal layer is sandwiched between the upper substrate and the lower substrate, and polarized films respectively disposed on outside surfaces the upper substrate and the lower substrate.

Wherein the first protrusion portion has a first top surface, the first flat portion has a second top surface, and a step difference is provided between the first top surface and the second top surface.

Wherein the second protrusion portion has a third top surface, the second flat portion has a fourth top surface, and a step difference is provided between the third top surface and the fourth top surface.

Wherein the second protrusion portion has a third top surface, the second flat portion has a fourth top surface, and a step difference is provided between the third top surface and the fourth top surface.

Wherein the first top surface contacts and presses against the fourth top surface, and a gap is existed between the third top surface and the second top surface such that the third top surface and the second top surface are not contacted.

Wherein the third top surface contacts and presses against the second top surface, and a gap is existed between the first top surface and the fourth top surface such that the first top surface and the fourth top surface are not contacted.

Wherein the first top surface contacts and presses against the fourth top surface, and the third top surface contacts and presses against the second top surface.

Implementing the liquid crystal display panel provided by the present invention has the beneficial effects: when the upper substrate and the lower substrate are aligned and assembled, the first protrusion portion presses against the second flat portion and/or the second protrusion portion presses against the first flat surface for supporting and interlocking the upper substrate and the lower substrate to improve the anti-compression ability. The present invention can form a cell thickness and form a secondary support when deformed by a large external force, and can effectively prevent slip and misalignment of the upper and lower substrates.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a schematic structural diagram of a liquid crystal display panel according to a first embodiment of the present invention;

FIG. 2 is a schematic structural diagram of a liquid crystal display panel according to a second embodiment of the present invention; and

FIG. 3 is a schematic structural diagram of a liquid crystal display panel according to a third embodiment of the present invention.

### DETAILED DESCRIPTION OF THE PREFERRED EMBODIMENT

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention.

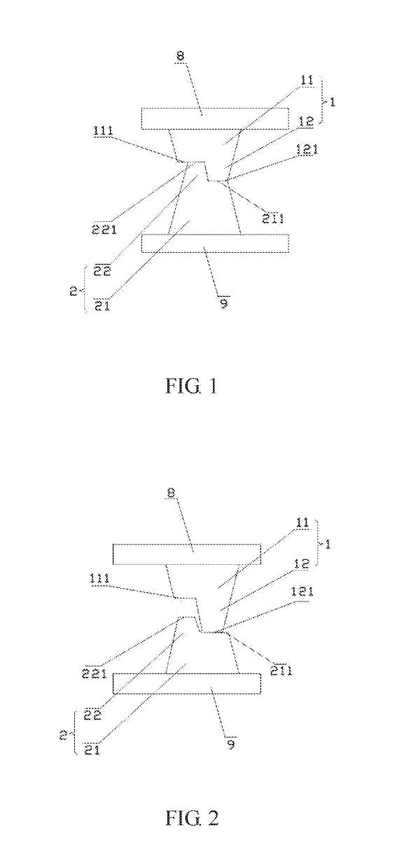

FIG. 1 shows a first embodiment of a liquid crystal display panel of the present invention.

The liquid crystal display panel in present embodiment includes an upper substrate 8, a lower substrate 9, a liquid crystal layer (not shown) sandwiched between the upper substrate 8 and the lower substrate 9, and polarized films respectively disposed on outside surfaces the upper substrate 8 and the lower substrate 9.

In the present embodiment, a first spacer 1 is provided at an inner surface 8a of the upper substrate 8. In a specific implementation, the number of the first spacer 1 disposed at the inner surface 8a of the upper substrate 8 is multiple, and the multiple first spacers 1 form an array. Wherein, the first spacer 1 is made of an organic material, which is adapted to be mated and engaged or compressed with a second spacer 2 deposed at the lower substrate 9 to form a cell gap such that a thickness of a center position and a thickness of both ends of the display panel are uniform in order to improve product yield.

Furthermore, the first spacer 1 includes a first flat portion 11 and a first protrusion portion 12 protruded from an end of the first flat portion 11. Wherein the first protrusion portion 12 has a first top surface 121, the first flat portion 11 has a second top surface 111, and a step difference is provided between the first top surface 121 and the second top surface 111. That is, by arranging the first protrusion portion 12 protruded from the first flat portion 11, high and low top surfaces 121, 111 are formed.

In the present embodiment, the second spacer 2 is provided at the inner surface of the lower substrate 9. In specific implementation, the number of the second spacers 2 provided at the inner surface 9a of the lower substrate 9 is multiple, and the multiple second spacers 2 form an array. In a specific implementation, when the upper substrate 8 and the lower substrate 9 are aligned and assembled, any first spacer 1 at the upper substrate 8 contacts or compresses the second spacer 2 at the lower substrate 9 in order to form a complete spacer structure.

Furthermore, the second spacer 2 is made of an organic material, which is prepared by the same material as the first spacer 1. Of course, the second spacer 2 can also be prepared using different materials without affecting the actual performance. The function of the second spacer 2 is to fit and align with the first spacer 1 at the upper substrate 8, or to form a liquid crystal cell gap (cell gap) with the first spacer 1 such that a thickness of a center position and a thickness of both ends of the display panel are uniform in order to improve product yield.

Furthermore, the second spacer 2 includes a second flat portion 21 and a second protrusion portion 22 protruded from an end of the second flat portion 21. Wherein the second protrusion portion 22 has a third top surface 221, the second flat portion 21 has a fourth top surface 211, and a step difference is provided between the third top surface 221 and the fourth top surface 211. That is, by arranging the second protrusion portion 22 protruded from the second flat portion 21, high and low top surfaces 221, 211 are formed.

In this embodiment, during the process of aligning and assembling the upper substrate 8 and the lower substrate 9, the first protrusion portion 12 presses against the second flat portion 21, and the second protrusion portion 22 presses against the first flat portion 11 in order to support and interlock the upper and lower substrates. Furthermore, the first top surface 121 contacts or presses against the fourth top surface 211, while the third top surface 221 contacts or presses against the second top surface 111.

In this embodiment, by arranging the first protrusion portion 12 protruded from the first flat portion 11 in order to form high and low top surfaces 121, 111, by arranging the second protrusion portion 22 protruded from the second flat portion 21 in order to form high and low top surfaces 221, 211, when the upper and lower substrates 8, 9 are aligned and assembled, and the first top surface 121 contacts or moderately compresses the fourth top surface 211, the third top surface 221 contacts or moderately compresses the second top surface 111. The upper and lower substrates 8, 9 can form a complete spacer substructure after being aligned and assembled together. The interlocking structure of upper and lower with a step difference can effectively prevent the slip and misalignment problem of the upper and lower substrates 8 and 9, and the above structure both has a Main PS and a Sub PS functions so as to improve the compression resistance and LC Margin ability.

As shown in FIG. 2, which shows a second embodiment of the liquid crystal display panel of the present invention.

The difference between the liquid crystal display panel in this embodiment and the first embodiment is that the step difference between the first top surface 121 of the first protrusion portion 12 and the second top surface 111 of the first flat portion 11 is different from the step difference between the third top surface 221 of the second protrusion portion 22 and the fourth top surface 211 of the second flat portion 21. Specifically, the first top surface 121 contacts and presses against the fourth top surface 211, and a gap is existed between the third top surface 221 and the second top surface 111 such that the third top surface and the second top surface are not contacted. The structure can have the following effects: when the panel structure is supported to form a cell gap, a certain deformation and compression space can be provided between the third top surface 221 and the second top surface 111 when being deformed by a large external force, and thus a secondary support is formed so that a single PS has both Main and Sub structures and functions.

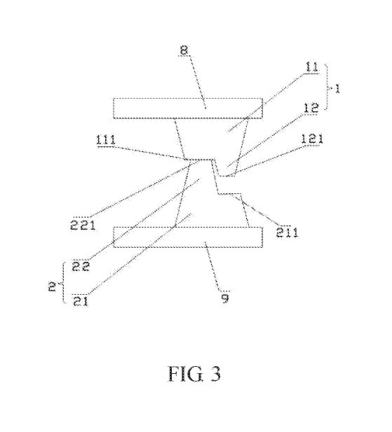

As shown in FIG. 3, which shows a third embodiment of the liquid crystal display panel of the present invention.

The difference between the liquid crystal display panel in this embodiment and the first embodiment is that the step difference between the first top surface 121 of the first protrusion portion 12 and the second top surface 111 of the first flat portion 11 is different from the step difference between the third top surface 221 of the second protrusion portion 22 and the fourth top surface 211 of the second flat portion 21. Specifically, the third top surface 221 contacts and presses against the second top surface 211, and a gap is existed between the first top surface 121 and the fourth top surface 211 such that the first top surface 121 and the fourth top surface 211 are not contacted. The structure can have the following effects: when the panel structure is supported to form a cell gap, a certain deformation and compression space can be provided between the third top surface 221 and the second top surface 111 when being deformed by a large external force, and thus a secondary support is formed so that a single PS has both Main and Sub structures and functions.

Implementing the liquid crystal display panel provided by the present invention has the beneficial effects: when the upper substrate and the lower substrate are aligned and assembled, the first protrusion portion presses against the second flat portion and/or the second protrusion portion presses against the first flat surface for supporting and interlocking the upper substrate and the lower substrate to improve the anti-compression ability. The present invention can form a cell thickness and form a secondary support when deformed by a large external force, and can effectively prevent slip and misalignment of the upper and lower substrates.

What is claimed is:

1. A liquid crystal display panel, comprising:
an upper substrate, wherein an inner surface of the upper substrate is provided with a first spacer, and the first spacer includes a first flat portion and a first protrusion portion protruded from an end of the first flat portion;
a lower substrate disposed oppositely to the upper substrate, wherein an inner surface of the upper substrate is provided with a second spacer, and the second spacer includes a second flat portion and a second protrusion portion protruded from an end of the second flat portion;
wherein during the process of aligning and assembling the upper substrate and the lower substrate, the first protrusion portion presses against the second flat portion and/or the second protrusion portion presses against the first flat portion in order to support and interlock the upper and lower substrates.

2. The liquid crystal display panel according to claim 1, wherein the first protrusion portion has a first top surface, the first flat portion has a second top surface, and a step difference is provided between the first top surface and the second top surface.

3. The liquid crystal display panel according to claim 1, wherein the second protrusion portion has a third top surface, the second flat portion has a fourth top surface, and a step difference is provided between the third top surface and the fourth top surface.

4. The liquid crystal display panel according to claim 2, wherein the second protrusion portion has a third top surface, the second flat portion has a fourth top surface, and a step difference is provided between the third top surface and the fourth top surface.

5. The liquid crystal display panel according to claim 4, wherein the first top surface contacts and presses against the fourth top surface, and a gap is existed between the third top surface and the second top surface such that the third top surface and the second top surface are not contacted.

6. The liquid crystal display panel according to claim 4, wherein the third top surface contacts and presses against the second top surface, and a gap is existed between the first top surface and the fourth top surface such that the first top surface and the fourth top surface are not contacted.

7. The liquid crystal display panel according to claim 4, wherein the first top surface contacts and presses against the fourth top surface, and the third top surface contacts and presses against the second top surface.

8. The liquid crystal display panel according to claim 1, wherein a liquid crystal layer is sandwiched between the upper substrate and the lower substrate, and polarized films respectively disposed on outside surfaces the upper substrate and the lower substrate.

9. The liquid crystal display panel according to claim 1, wherein multiple first spacers are formed at an inner surface of the upper substrate as an array, multiple second spacers are formed at an inner surface of the lower substrate as an array, when the upper substrate and the lower substrate are aligned and assembled, any first spacer at the upper substrate contacts or compresses the second spacer at the lower substrate in order to form a complete spacer structure.

10. The liquid crystal display panel according to claim 1, wherein a material of the first spacer and a material of the second spacer are the same.

11. A liquid crystal display panel, comprising:
an upper substrate, wherein an inner surface of the upper substrate is provided with a first spacer, and the first spacer includes a first flat portion and a first protrusion portion protruded from an end of the first flat portion;
a lower substrate disposed oppositely to the upper substrate, wherein an inner surface of the upper substrate is provided with a second spacer, and the second spacer includes a second flat portion and a second protrusion portion protruded from an end of the second flat portion;
wherein during the process of aligning and assembling the upper substrate and the lower substrate, the first protrusion portion presses against the second flat portion and/or the second protrusion portion presses against the first flat portion in order to support and interlock the upper and lower substrates;
wherein a material of the first spacer and a material of the second spacer are the same; and
wherein a liquid crystal layer is sandwiched between the upper substrate and the lower substrate, and polarized films respectively disposed on outside surfaces the upper substrate and the lower substrate.

12. The liquid crystal display panel according to claim 11, wherein the first protrusion portion has a first top surface, the first flat portion has a second top surface, and a step difference is provided between the first top surface and the second top surface.

13. The liquid crystal display panel according to claim 11, wherein the second protrusion portion has a third top surface, the second flat portion has a fourth top surface, and a step difference is provided between the third top surface and the fourth top surface.

14. The liquid crystal display panel according to claim 12, wherein the second protrusion portion has a third top surface, the second flat portion has a fourth top surface, and a step difference is provided between the third top surface and the fourth top surface.

15. The liquid crystal display panel according to claim 14, wherein the first top surface contacts and presses against the fourth top surface, and a gap is existed between the third top surface and the second top surface such that the third top surface and the second top surface are not contacted.

16. The liquid crystal display panel according to claim 14, wherein the third top surface contacts and presses against the second top surface, and a gap is existed between the first top surface and the fourth top surface such that the first top surface and the fourth top surface are not contacted.

17. The liquid crystal display panel according to claim 14, wherein the first top surface contacts and presses against the fourth top surface, and the third top surface contacts and presses against the second top surface.
